(19) United States
(12) Patent Application Publication
(10) Pub. No.: US 2025/0115344 A1
(43) Pub. Date: Apr. 10, 2025

(54) MAGNETOHYDRODYNAMIC SEAWATER PROPULSION THRUSTER

(71) Applicant: KOREA ATOMIC ENERGY RESEARCH INSTITUTE, Daejeon (KR)

(72) Inventors: Doo-Hee CHANG, Daejeon (KR); Jong Pil PARK, Daejeon (KR)

(73) Assignee: KOREA ATOMIC ENERGY RESEARCH INSTITUTE, Daejeon (KR)

(21) Appl. No.: 18/987,881

(22) Filed: Dec. 19, 2024

Related U.S. Application Data
(63) Continuation of application No. PCT/KR2024/003064, filed on Mar. 11, 2024.

(30) Foreign Application Priority Data
Jun. 23, 2023 (KR) 10-2023-0081116

(51) Int. Cl. B63H 19/00; B63H 21/21; B63H 21/38

(52) U.S. Cl. CPC B63H 19/00; B63H 21/21; B63H 21/38

(57) ABSTRACT

A magnetohydrodynamic seawater propulsion thruster includes: a first electrode body including a seawater inlet, a seawater flow space, and a seawater outlet; a second electrode body arranged in the seawater flow space to be spaced apart from the first electrode body, and allowing current to flow through the seawater with the first electrode body; a flow guide having a helical shape, arranged between the first electrode body and the second electrode body in the seawater flow space to guide flowing of seawater; a magnetic field formation unit arranged to surround at least a portion of an outer circumference of the first electrode body and generate a magnetic field in an extension direction of the first electrode body; a power supply unit that supplies electricity to the first and second electrode bodies. The power supply unit includes a fuel cell module generating electricity through electrochemical reaction of fuel and oxidizer.

### CROSS-REFERENCE TO RELATED APPLICATION

This application is a bypass continuation application of International Application No. PCT/KR2024/003064, filed on Mar. 11, 2024, which is based on and claims the benefit of Korean Patent Application No. 10-2023-0081116, filed on Jun. 23, 2023 in the Korean Intellectual Property Office, the disclosure of which is incorporated by reference herein in its entirety.

### BACKGROUND

### Field

The present disclosure relates to a magnetohydrodynamic seawater propulsion thruster.

This research is related to the Research Operating Expense Support Project of the Korea Atomic Energy Research Institute (Project ID: 1711195839, Reseach Period: Jan. 1, 2023-Dec. 31, 2023, Project Title: Evaluation and Verification of Atomic/Nuclear Reaction Characteristecs Data), funded by the Ministry of Science and ICT (Government) and conducted by the Korea Atomic Energy Research Institute.

### Description of the Related Art

Currently, research on helical-type magnetohydrodynamic (MHD) seawater propulsion thrusters is primarily being conducted abroad, particularly in countries such as Japan, China, and the United States.

The magnetohydrodynamic seawater propulsion thruster generates thrust by applying a current to seawater in a magnetic field, which produces Lorentz force, causing the conductive fluid, seawater, to be ejected at high speed. The magnetohydrodynamic seawater propulsion thruster is being developed to propel ships and vessels without the need for a propeller. It offers the advantage of overcoming various issues associated with propeller-driven systems, such as hull vibrations, propeller erosion (pitting), and speed limitations. In particular, the magnetohydrodynamic seawater propulsion thruster has the advantage of generating minimal impact on bubble noise during seawater propulsion, and it also exhibits a very small range of downstream instability. These features make it highly advantageous for stealth, covert, and evasive maneuvering in special-purpose vessels. Additionally, the magnetohydrodynamic seawater propulsion thruster offers near-silent propulsion performance and is environmentally friendly, making it a promising technology for future naval propulsion. The magnetohydrodynamic seawater propulsion thruster has no limitation on maximum speed when the magnetic field strength and applied current are increased. Additionally, by changing the direction of the magnetic field or the applied current, the propulsion direction can be reversed, making it highly advantageous for enhancing the maneuverability of the vessel.

Meanwhile, the power required for the operation tests of the magnetohydrodynamic seawater propulsion thruster is mainly supplied by commercial power in laboratory settings to verify its propulsion performance. However, this reliance on commercial power supply is one of the critical technical challenges that must be overcome for the commercialization of the magnetohydrodynamic seawater propulsion thruster. Although commercial battery-based power sources can be used, this requires addressing challenges such as the periodic charging and discharging process, as well as the risk of battery explosions and fires. Therefore, securing a power source that can provide stable and reliable long-term energy supply is a crucial factor for the commercialization of the magnetohydrodynamic seawater propulsion engine.

### SUMMARY

The embodiments of the present disclosure have been developed in the background described above, aiming to provide a magnetohydrodynamic seawater propulsion thruster that can be commercialized by securing a power source capable of providing stable and reliable long-term energy supply.

In accordance with one aspect of the present disclosure, there is provided a magnetohydrodynamic seawater propulsion thruster including: a first electrode body having a cylindrical shape, and including a seawater inlet, a seawater flow space through which seawater flows, and a seawater outlet through which the seawater flowing through the seawater flow space is discharged; a second electrode body arranged in the seawater flow space to be spaced apart from the first electrode body, and configured to allow a current to flow through the seawater flowing in the seawater flow space in conjunction with the first electrode body; a flow guide having a helical shape, arranged between the first electrode body and the second electrode body in the seawater flow space to guide a flow of seawater; a magnetic field formation unit arranged to surround at least a portion of an outer circumference of the first electrode body and generate a magnetic field in an extension direction of the first electrode body; a power supply unit that supplies electricity to the first electrode body and the second electrode body, wherein the power supply unit includes a fuel cell module configured to generate electricity through an electrochemical reaction of fuel and oxidizer.

Further, the fuel cell module may include a plurality of fuel cell modules, and the plurality of fuel cell modules are connected in parallel to each other.

Further, the magnetic field formation unit may be a solenoid magnet or a solenoid superconducting magnet, and the power supply unit may supply electricity to the magnetic field formation unit.

Further, the power supply unit may include: a fuel storage tank in which fuel is stored, and from which the stored fuel is supplied to each of the plurality of fuel cell modules; and a converter that receives electricity from each of the plurality of fuel cell modules and supplies electricity to the first electrode body, the second electrode body, and the magnetic field formation unit.

Further, the converter may convert a direct current supplied from the plurality of fuel cell modules into a direct current with a predetermined current value to supply the direct current with the predetermined current value to the first electrode body, the second electrode body, and the magnetic field formation unit, respectively.

Further, the magnetohydrodynamic seawater propulsion thruster may further include: a controller connected to the power supply unit to control a supply of electricity from the power supply unit, the power supply unit may further include an inverter that receives electricity from each of the plurality of fuel cell modules and supplies electricity to the controller

Further, the inverter may convert a direct current received from each of the plurality of fuel cell modules into an alternating current and supply the alternating current to the controller.

According to the embodiments of the present disclosure, a power source capable of providing long-term and stable supply for the magnetohydrodynamic seawater propulsion thruster can be secured, thereby enabling the commercialization of the magnetohydrodynamic seawater propulsion thruster.

### BRIEF DESCRIPTION OF THE DRAWINGS

FIG. 1 shows a magnetohydrodynamic seawater propulsion thruster according to an embodiment of the present disclosure.

FIG. 2 shows a configuration of an electric supply unit of the magnetohydrodynamic seawater propulsion thruster according to the embodiment of the present disclosure.

FIG. 3 shows an operation of the magnetohydrodynamic seawater propulsion thruster according to the embodiment of the present disclosure.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, or ‘contacted’ with, another element, it should be understood that the element may be directly connected to, supported by, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as radial direction, tangential direction, and the like are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, the specific configuration of the magnetohydrodynamic seawater propulsion thruster according to an embodiment of the present disclosure will be described. The magnetohydrodynamic seawater propulsion thruster 1 is designed to discharge the incoming seawater at a relatively high speed, thereby propelling vessels, such as ships, equipped with the thruster 1 in the ocean. The magnetohydrodynamic seawater propulsion thruster 1 may include a first electrode body 100, a second electrode body 200, a flow guide 300, a magnetic field formation unit 400, an electric supply unit 500, and a controller 600.

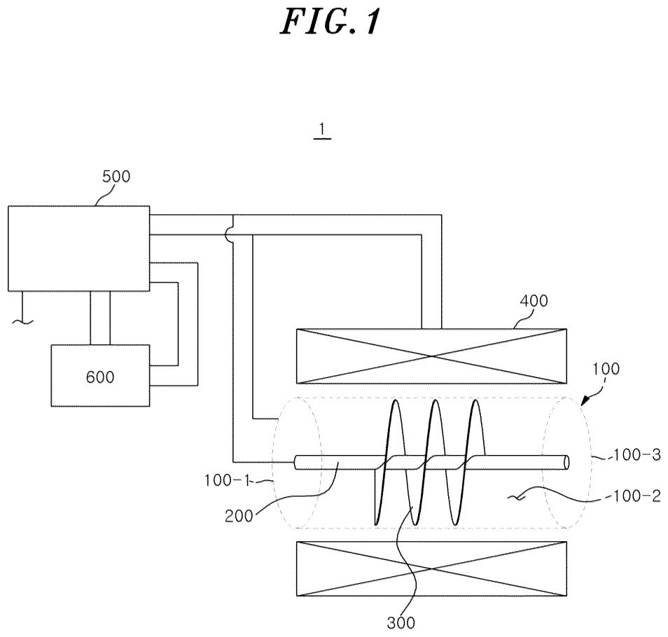

Referring to FIG. 1, the first electrode body 100 is designed to allow seawater to enter, flow through, and be discharged. The first electrode body 100 includes a seawater inlet 100-1, a seawater flow space 100-2, and a seawater outlet 100-3. Seawater may flow into the first electrode body 100 through the seawater inlet 100-1. The seawater flowing into the first electrode body 100 may flow through the seawater flow space 100-2. The seawater that flows through the seawater flow space 100-2 may be discharged through the seawater outlet 100-3. The first electrode body 100 may be approximately cylindrical in shape. For example, the first electrode body 100 may have a hollow cylindrical shape. Additionally, the seawater inlet 100-1 may be formed on one side of the cylindrical first electrode body 100, with the seawater flow space 100-2 formed inside, and the seawater outlet 100-3 formed on the other side. The first electrode body 100, together with the second electrode body 200, may allow current to flow through the seawater flowing in the seawater flow space 100-2. The first electrode body 100, together with the second electrode body 200, may allow current to flow through the seawater in the seawater flow space 100-2 in a direction perpendicular to a direction of the magnetic field formed by the magnetic field formation unit 400. For example, the first electrode body 100 has a cylindrical shape, the magnetic field is formed along an extension direction (forward or reverse) of the first electrode body 100 by the magnetic field formation unit 400, and the first electrode body 100 and the second electrode body 200 may allow current to flow in a radial direction of the first electrode body 100 through seawater flowing in the seawater flow space 100-2. The first electrode body 100 may be either a cathode (−) or an anode (+), and may be connected to the cathode (−) or anode (+) of the power supply unit 500.

The second electrode body 200, together with the first electrode body 100, may allow current to flow through the seawater flowing in the seawater flow space 100-2 of the first electrode body 100. The second electrode body 200, along with the first electrode body 100, may allow current to flow in the direction perpendicular to the magnetic field formed by the magnetic field formation unit 400 in the seawater flowing through the seawater flow space 100-2. For example, the first electrode body 100 has a cylindrical shape, a magnetic field is formed in the extension direction of the first electrode body 100 by the magnetic field formation unit 400, and the second electrode body 200 and the first electrode body 100 may allow current to flow in the radial direction of the first electrode body 100 through the seawater flowing in the seawater flow space 100-2. The second electrode body 200 may be arranged in the seawater flow space 100-2 to be spaced apart from the first electrode body 100. A distance between the second electrode body 200 and the first electrode body 100 may such a distance that electrical breakdown does not occur even when electricity is supplied to the second electrode body 200 and the first electrode body 100. For example, the second electrode body 200 may be positioned at the center of the seawater flow space 100-2. Further, the second electrode body 200 may have a rod shape. For instance, the second electrode body 200 may have a cylindrical rod shape. The second electrode body 200 may be either an anode (+) or a cathode (−), and may be connected to the anode (+) or cathode (−) of the power supply unit 500.

The flow guide 300 may guide (direct) the flow of seawater in the seawater flow space 100-2 of the first electrode body 100. The flow guide 300 may be disposed between the first electrode body 100 and the second electrode body 200 in the seawater flow space 100-2 of the first electrode body 100. The flow guide 300 may have a spiral shape. Therefore, the seawater flowing through the seawater flow space 100-2 of the first electrode body 100 can flow in a spiral pattern due to the flow guide 300. The flow guide 300 may extend from the second electrode body 200 and may be radially spaced from the first electrode body 100 by a predetermined distance, such as several centimeters or more, to ensure that electrical breakdown does not occur. Additionally, the flow guide 300 may be made of an insulator. Since the flow guide 300 is formed from an insulating material, even if at least a portion of the flow guide 300 comes into contact with the first electrode body 100 and the second electrode body 200, the first electrode body 100 and the second electrode body 200 may not be electrically connected through the flow guide 300.

The magnetic field formation unit 400 may generate a magnetic field in the extension direction of the first electrode body 100. The magnetic field formed by the magnetic field formation unit 400, along with the current generated by the first electrode body 100 and the second electrode body 200 to flow through the seawater in the seawater flow space 100-2 of the first electrode body 100, may generate a Lorentz force on the seawater flowing through the seawater flow space 100-2. In other words, the Lorentz force perpendicular to both the direction of the magnetic field and the direction of the current may act on the seawater flowing through the seawater flow space 100-2 of the first electrode body 100. For example, if the first electrode body 100 has a cylindrical shape, a magnetic field may be formed in the direction of the extension of the first electrode body 100 by the magnetic field formation unit 400. Additionally, the current generated by the first electrode body 100 and the second electrode body 200 may flow in the radial direction of the first electrode body 100 through the seawater flowing in the seawater flow space 100-2. Furthermore, the Lorentz force may act in the tangential direction of the first electrode body 100 on the seawater flowing through the seawater flow space 100-2. The seawater, subjected to the Lorentz force, may flow in a spiral shape through the seawater flow space 100-2 of the first electrode body 100 and be discharged through the seawater outlet 100-3. Additionally, due to the action and reaction forces resulting from the discharge of seawater through the seawater outlet 100-3 of the first electrode body 100, a thrust may be generated in the opposite direction of the seawater being discharged from the seawater propeller 1.

The magnetic field formation unit 400 may be arranged to surround at least a portion of the outer circumference of the first electrode body 100. For example, the magnetic field formation unit 400 may have a hollow cylindrical shape to surround at least a portion of the outer circumference of the first electrode body 100. Further, a single magnetic field formation unit 400 may include a plurality of magnetic field generating sections along a longitudinal direction thereof and may surround the entire outer circumference of the first electrode body 100. The magnetic field formation unit 400, which includes the plurality of magnetic field generating sections, generates a magnetic field in the portions corresponding to the plurality of magnetic field generating sections along the longitudinal direction of the first electrode body 100. Meanwhile, the plurality of magnetic field non-generating sections may be positioned in a way that minimizes the influence of the leakage magnetic field on the equipment of the magnetohydrodynamic seawater propulsion thruster 1 and the human body. The magnetic field formation unit 400 may be a solenoid magnet or a solenoid superconducting magnet, and may generate a uniform magnetic field of more than 5 Tesla inside the first electrode body 100. In addition, electricity may be supplied to the magnetic field formation unit 400 by the power supply unit 500, enabling the magnetic field formation unit 400 to generate a magnetic field.

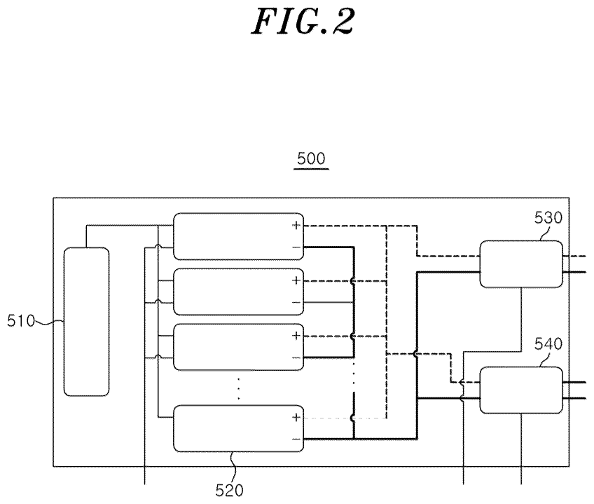

Referring to FIG. 2, the power supply unit 500 may supply electricity to the first electrode body 100, the second electrode body 200, the magnetic field formation unit 400, and the controller 600. The power supply unit 500 may include a fuel storage tank 510, a plurality of fuel cell modules 520, a converter 530, and an inverter 540.

The fuel storage tank 510 stores fuel and may be connected to each of the plurality of fuel cell modules 520 such that the stored fuel is supplied to each of the plurality of fuel cell modules 520. For example, the fuel stored in the fuel storage tank 510 may be hydrogen (H).

Each of the plurality of fuel cell modules 520 may be configured to generate electricity through the electrochemical reaction of fuel and an oxidizer. The plurality of fuel cell modules 520 may be each connected to the fuel storage tank 510 and may receive fuel stored in the fuel storage tank 510. Further, the plurality of fuel cell modules 520 may each receive external air as an oxidizer. Furthermore, although not shown, the power supply unit 500 may further include an oxidizer storage tank in which the oxidizer is stored, and each of the plurality of fuel cell modules 520 may be connected to the oxidizer storage tank to receive the oxidizer stored in the oxidizer storage tank. In each of the plurality of fuel cell modules 520, the supplied fuel and oxidizer undergo an electrochemical reaction to generate direct current (DC) electricity. The plurality of fuel cell modules 520 may be connected in parallel.

The converter 530 may receive power from each of the plurality of fuel cell modules 520 and may supply the power to the first electrode body 100, the second electrode body 200, and the magnetic field formation unit 400. The converter 530 may convert the direct current supplied from the plurality of fuel cell modules 520 into a direct current with a predetermined current value and may supply the direct current to the first electrode body 100, the second electrode body 200, and the magnetic field formation unit 400, respectively. The inverter 540 may convert the direct current received from the plurality of fuel cell modules 520 into an alternating current and may supply the alternating current to the controller 600.

The controller 600 may control the power supply from the power supply unit 500. The controller 600 may be connected to the power supply unit 500. For example, the controller 600 may be connected to the converter 530 and inverter 540 of the power supply unit 500. Additionally, the controller 600 may control the converter 530 to ensure that a predetermined amount of power is supplied to the first electrode body 100, the second electrode body 200, and the magnetic field formation unit 400, respectively. Furthermore, the controller 600 may control the inverter 540 to ensure that a predetermined amount of power is supplied to the controller 600. The controller may be implemented by computational devices such as a microprocessor, memory, and the like, and the implementation method is self-evident to those skilled in the art, so further detailed explanation is omitted.

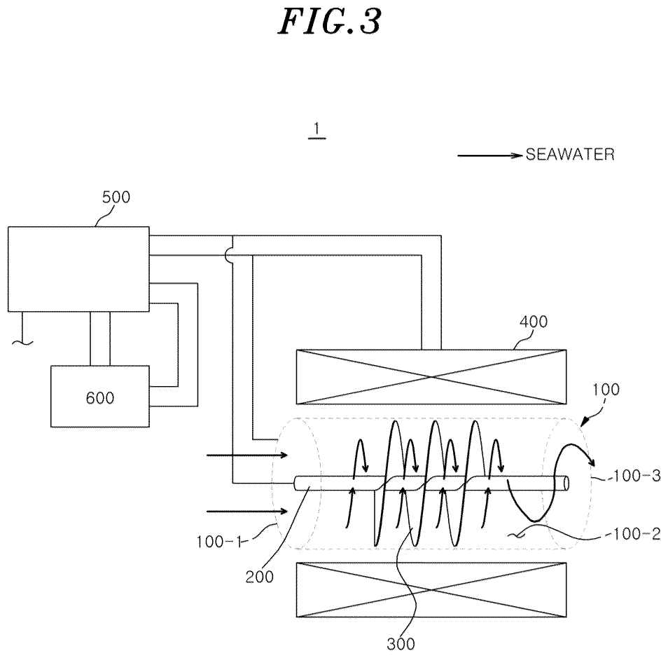

Hereinafter, with reference to FIG. 3, the operation and effects of the magnetohydrodynamic seawater propulsion thruster 1 with the configuration described above will be explained.

When the magnetohydrodynamic seawater propulsion thruster 1 is submerged in seawater, seawater may fill the space between the first electrode body 100 and second electrode body 200, that is, the seawater flow space 100-2 of the first electrode body 100. With seawater filling the seawater flow space 100-2 of the first electrode body 100, the controller 600 may cause electricity to be supplied to the first electrode body 100 and the second electrode body 200 from the power supply unit 500. Further, the controller 600 may also cause electricity to be supplied to the magnetic field formation unit 400 from the power supply unit 500.

Therefore, in the seawater of the seawater flow space 100-2 of the first electrode body 100, a current flows due to the first electrode body 100 and the second electrode body 200, and a magnetic field may be formed in the extension direction of the first electrode body 100 by the magnetic field formation unit 400. Additionally, in the seawater of the seawater flow space 100-2 of the first electrode body 100, a Lorentz force may act on the seawater due to the current from the first electrode body 100 and second electrode body 200 and the magnetic field from the magnetic field formation unit 400. For example, a Lorentz force may act in the tangential direction of the cylindrical first electrode body 100 on the seawater flowing through the seawater flow space 100-2. The seawater may flow in a spiral shape from the seawater flow space 100-2 due to the Lorentz force.

The controller 600 may control the current flowing through the first electrode body 100 and the second electrode body 200 or the direction of the magnetic field generated by the magnetic field formation unit 400, so that seawater flows into the first electrode body 100 through the seawater inlet 100-1, spirals through the seawater flow space 100-2, and is then discharged through the seawater outlet 100-3. Further, the controller 600 may control the current flowing through the first electrode body 100 and the second electrode body 200 or the direction of the magnetic field generated by the magnetic field formation unit 400, so that seawater flows into the first electrode body 100 through the seawater outlet 100-3, spirals through the seawater flow space 100-2, and is then discharged through the seawater inlet 100-1.

Due to the discharge of seawater through the seawater outlet 100-3 of the first electrode body 100 or through the seawater inlet 100-1, a thrust may be generated in the direction opposite to the seawater discharge direction for the magnetohydrodynamic seawater propulsion thruster 1. This thrust allows the magnetohydrodynamic seawater propulsion thruster 1, or a ship equipped with the magnetohydrodynamic seawater propulsion thruster 1, to be propelled forward or rearward in marine environments.

Meanwhile, the power supply unit 500 may generate electricity through the electrochemical reaction of fuel and oxidizer in the plurality of fuel cell modules 520, and may supply electricity to the first electrode body 100, the second electrode body 200, the magnetic field formation unit 400, and the controller 600. Therefore, by continuously supplying fuel and oxidizer to the plurality of fuel cell modules 520, electricity may be continuously generated through the electrochemical reaction of fuel and oxidizer in the plurality of fuel cell modules 520. Additionally, electricity may be continuously supplied to the first electrode body 100, the second electrode body 200, the magnetic field formation unit 400, and the controller 600. As a result, a power source capable of stable long-term supply can be secured, making the commercialization of the magnetohydrodynamic seawater propulsion thruster 1 possible.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A magnetohydrodynamic seawater propulsion thruster comprising:
a first electrode body having a cylindrical shape, and including a seawater inlet, a seawater flow space through which seawater flows, and a seawater outlet through which the seawater flowing through the seawater flow space is discharged;
a second electrode body arranged in the seawater flow space to be spaced apart from the first electrode body, and configured to allow a current to flow through the seawater flowing in the seawater flow space in conjunction with the first electrode body;
a flow guide having a helical shape, arranged between the first electrode body and the second electrode body in the seawater flow space to guide a flow of seawater;
a magnetic field formation unit arranged to surround at least a portion of an outer circumference of the first electrode body and generate a magnetic field in an extension direction of the first electrode body;
a power supply unit that supplies electricity to the first electrode body and the second electrode body,
wherein the power supply unit includes a fuel cell module configured to generate electricity through an electrochemical reaction of fuel and oxidizer.

2. The magnetohydrodynamic seawater propulsion thruster of claim 1, wherein the fuel cell module includes a plurality of fuel cell modules, and the plurality of fuel cell modules are connected in parallel to each other.

3. The magnetohydrodynamic seawater propulsion thruster of claim 1, wherein the magnetic field formation unit is a solenoid magnet or a solenoid superconducting magnet, and the power supply unit supplies electricity to the magnetic field formation unit.

4. The magnetohydrodynamic seawater propulsion thruster of claim 3, wherein the power supply unit includes:
a fuel storage tank in which fuel is stored, and from which the stored fuel is supplied to each of the plurality of fuel cell modules; and
a converter that receives electricity from each of the plurality of fuel cell modules and supplies electricity to the first electrode body, the second electrode body, and the magnetic field formation unit.

5. The magnetohydrodynamic seawater propulsion thruster of claim 4, wherein the converter converts a direct current supplied from the plurality of fuel cell modules into a direct current with a predetermined current value to supply the direct current with the predetermined current value to the first electrode body, the second electrode body, and the magnetic field formation unit, respectively.

6. The magnetohydrodynamic seawater propulsion thruster of claim 4, further comprising:
a controller connected to the power supply unit to control a supply of electricity from the power supply unit,
wherein the power supply unit further includes an inverter that receives electricity from each of the plurality of fuel cell modules and supplies electricity to the controller.

7. The magnetohydrodynamic seawater propulsion thruster of claim 6, wherein the inverter converts a direct current received from each of the plurality of fuel cell modules into an alternating current and supplies the alternating current to the controller.
